(19) United States
(12) Patent Application Publication
(10) Pub. No.: US 2004/0010556 A1
(43) Pub. Date: Jan. 15, 2004

(54) Electronic document information expansion apparatus, electronic document information expansion method , electronic document information expansion program, and recording medium which records electronic document information expansion program

(75) Inventors: Yasuhiro Kawakita, Osaka (JP); Atsushi Ikeno, Kyoto (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/603,665

(22) Filed: Jun. 26, 2003

(30) Foreign Application Priority Data
Jun. 27, 2002 (JP) JP2002-187695
Jan. 9, 2003 (JP) JP2003-2978

(51) Int. Cl. G06F 15/16

(52) U.S. Cl. 709/206

(57) ABSTRACT

Information on an electronic document including location information on related data is expanded. In the present invention, the location information on the data included in an input electronic document is extracted from the electronic document, external data which can be added to the electronic document is acquired based on the extracted location information, and information on an element which the input electronic document is short of is expanded from the acquired external data.

### BACKGROUND OF THE INVENTION

The present invention relates to an electronic document information expansion apparatus which expands information on an element which an electronic document does not include, and which can be, for example, applied to an information management system which deals with e-mail documents as information sources.

### DESCRIPTION OF THE RELATED ART

In recent years, it has been normally conducted to describe locations (e.g., URL and URI, which will be referred to as “URL” hereinafter) of related information in e-mail documents and transmit the e-mail. To correspond to the development, e-mail viewing software have been contrived in various manners so as to, for example, start a Web browser software only by selecting the URL of related information. However, at the time when an e-mail arrives, information at a location indicated by a URL is not acquired yet, so that a user needs to perform an operation for acquiring the information.

Considering this disadvantage, a method for automatically acquiring information (such as an HTML document) at a location indicated by a URL and storing the information while the information is associated with a received e-mail if the location of information to be referred to is indicated by a URL in the e-mail is disclosed in Japanese Patent Laid-open Publication No. 2001-184277. According to this method, a user who received the e-mail can view already acquired data by means of a display device only by designating the URL in the e-mail documents even if a user's computer is disconnected from the network.

According to the method disclosed in Japanese Patent Laid-open Publication No. 2001-184277, all pieces of data at the URL included in an e-mail document are acquired while being associated with the e-mail. Due to this, there is a probability that even parts unrelated to the content of the e-mail documents are acquired. Thus, although this conventional method advantageously enables the user to view the URL data even if the computer is disconnected from the network, the method has a disadvantage in that storage efficiency is deteriorated.

Furthermore, when a company's URL is indicated, for example, the URL often links to the top page of the company's website. If data on this top page is stored, it is required to look for information related to the content of the e-mail document by tracking links from the top page. According to the method disclosed in Japanese Patent Laid-open Publication No. 2001-184277, the data on the designated page of the URL is acquired and stored. Due to this, while the user's computer is disconnected from the network, it is disadvantageously impossible to further look for links.

Moreover, if the quantity of one e-mail document is small, the e-mail cannot be matched with sufficient keywords, with the result that it is disadvantageously impossible to accurately acquire a necessary e-mail.

In these circumstances, therefore, demand for an electronic document information expansion apparatus, an electronic document information expansion method, and an electronic document information expansion program which can expand information on an electronic document including the locations of related information, and a recording medium which records the electronic document information expansion program rises.

### SUMMARY OF THE INVENTION

According to one aspect of the present invention, there is provided an electronic document information expansion apparatus for expanding information on an electronic document, characterized by including:

(1) an input section inputting the electronic document; and an information analysis section extracting location information on data included in an input electronic document from the electronic document;

(2) an external data acquisition section acquiring external data that can be added to the electronic document based on the extracted location information;

(3) an information addition section generating addition data to be added to the electronic document using the acquired external data; and

(4) a structured data generation section combining the addition data generated by the information addition section with the electronic document, and generating structured data with the information on the electronic document expanded.

According to another aspect of the present invention, there is provided an electronic document information expansion method for expanding information on an electronic document, characterized by including:

(1) an information analysis step of extracting location information on data included in an input electronic document from the electronic document;

(2) an external data acquisition step of acquiring external data that can be added to the electronic document based on the extracted location information;

(3) an information addition step of generating addition data to be added to the electronic document using the acquired external data; and

(4) a structured data generation step of combining the addition data generated in the information addition step with the electronic document, and generating structured data with the information on the electronic document expanded.

According to yet another aspect of the present invention, there is provided an electronic document information expansion program characterized in that the steps of the electronic document information expansion method according the present invention are described in codes that can be processed by a computer.

According to still another aspect of the present invention, there is provided a recording medium characterized by recording the electronic document information expansion program according to the present invention.

### BRIEF DESCRIPTION OF THE DRAWINGS

FIG. 1 is a block diagram showing the functional configuration of an electronic document information expansion apparatus (e-mail document information expansion apparatus) in one embodiment according to the present invention;

FIG. 2 is a flow chart showing the overall operation of the electronic document information expansion apparatus in this embodiment;

FIG. 3 is an explanatory view showing one example of an e-mail document;

FIG. 4 is an explanatory view showing an example of the result of an information unit expansion processing for the document shown in FIG. 3 performed by an information analysis section in this embodiment;

FIG. 5 is an explanatory view showing an example of an URL extraction result for an extracted information unit extracted by the information analysis section in this embodiment;

FIG. 6 is an explanatory view showing an example of the acquisition result of an external data acquisition section in this embodiment;

FIG. 7 is an explanatory view showing an example of the processing result of a keyword extraction processing in this embodiment;

FIG. 8 is an explanatory view showing an example of the processing result of an important part extraction processing in this embodiment; and

FIG. 9 is an explanatory view showing an example of structured data obtained by a structured data generation processing in this embodiment.

### DETAILED DESCRIPTION OF THE PREFERRED EMBODIMENTS

One embodiment of an electronic document information expansion apparatus, an electronic document information expansion method, an electronic document information expansion program and a recording medium which records an electronic document information expansion program according to the present invention will be described hereinafter in detail with reference to the accompanying drawings.

In this embodiment, an information source indicated by a URL is accessed, a content related to each piece of information is acquired from the information source, keyword extraction is performed, and structured data including the result of the keyword extraction is generated for an e-mail document.

### Configuration of Embodiment

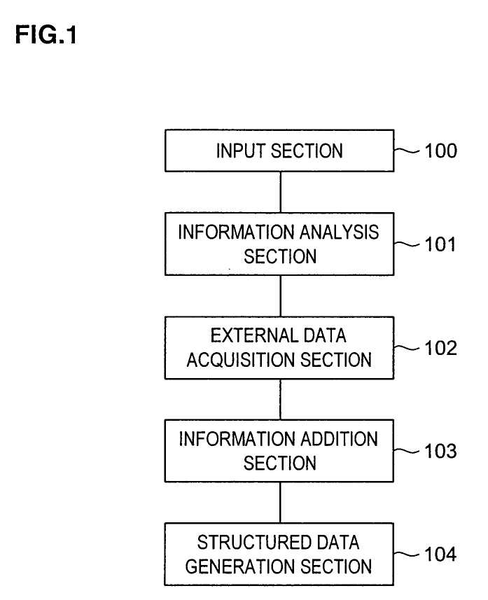

FIG. 1 is a block diagram showing the functional configuration of an electronic document information expansion apparatus in this embodiment.

The electronic document information expansion apparatus in this embodiment is realized by installing an electronic document information expansion program (for example, addition function of e-mail viewing software) recorded on a recording medium such as a CD-ROM or a floppy disk (trademark) to, for example, a user's information processing apparatus (a mail client) such as a personal computer having a communication function. Functionally, the electronic document information expansion apparatus can be represented by FIG. 1. In addition, the electronic document information expansion apparatus can be realized by, for example, installing the electronic document information expansion program recorded on the recording medium such as a CD-ROM or a floppy disk (trademark) to, for example, a mail server. In this case, similarly to the above case, the electronic document information expansion apparatus can be functionally represented by FIG. 1.

The electronic document information expansion apparatus in this embodiment includes an input section 100, an information analysis section 101, an external data acquisition section 102, an information addition section 103 and a structured data generation section 104.

The input section 100 inputs an e-mail document (e.g., a mail magazine) which includes an URL indicating information and the information source of information related to the former information (note that the location of the information source may be a URI, an FTP or a file name; however, this embodiment will be described while assuming that the location is the URL). The input of the e-mail document may mean that an e-mail document is fetched at the time of input or that the e-mail document previously fetched and stored is read.

The information analysis section 101 divides an input e-mail document into individual information units and extracts URL that indicates an information source from each information unit. If the e-mail document is, for example, a news mail magazine, the information analysis section 101 divides the e-mail document into information units each having one article. The information analysis section 101 then extracts an URL included in each information unit.

The external data acquisition section 102 acquires detailed data similar to a content described in each information unit divided in the information analysis section 101 from an external information source indicated by a URL or the like based on the URL included in the information unit. The external data acquisition section 102 determines whether data is worthy of acquisition based on the similarity between original sentences described in each information unit and data acquired from the information source indicated by the URL or the like.

The information addition section 103 extracts keywords and important parts from the data acquired by the external data acquisition section 102, and generates addition data to be added to each original information unit.

The structured data generation section 104 combines the addition data generated by the information addition section 103 with the original information units and generates structured data.

### Operation of Embodiment

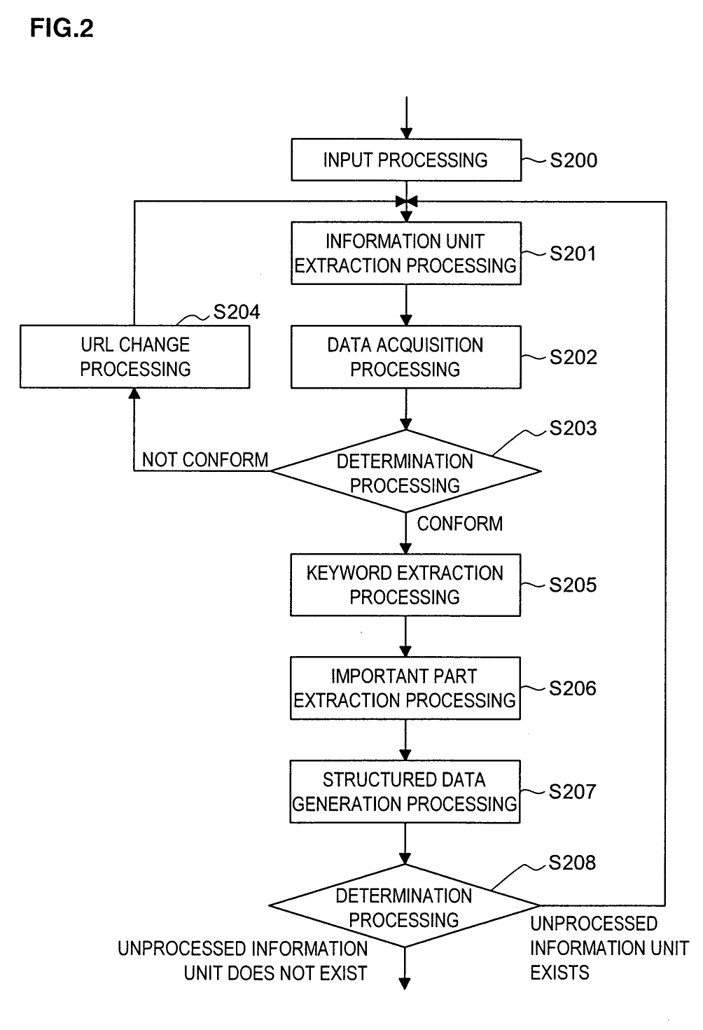

FIG. 2 is a flow chart showing the overall operation of the electronic document information expansion apparatus in this embodiment (an electronic document information expansion apparatus method).

In this embodiment, as an example of the information unit, it is assumed that title <TITLE>, summary <BODY>, keyword <KEYWORD>, and location of information source <URL> are essential contents that constitute each information unit and the generation of structured data that includes all of the essential contents will be described. Further, while keywords are generated in all cases, an example in which an e-mail document is short of a summary after the e-mail document is subjected to a division processing will be described.

In an input processing of a step S200, the input section 100 inputs an e-mail document.

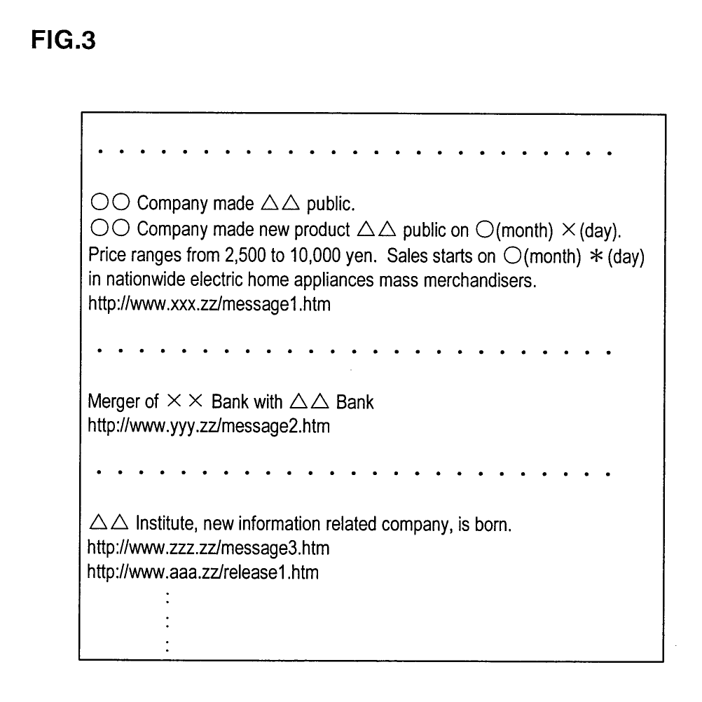

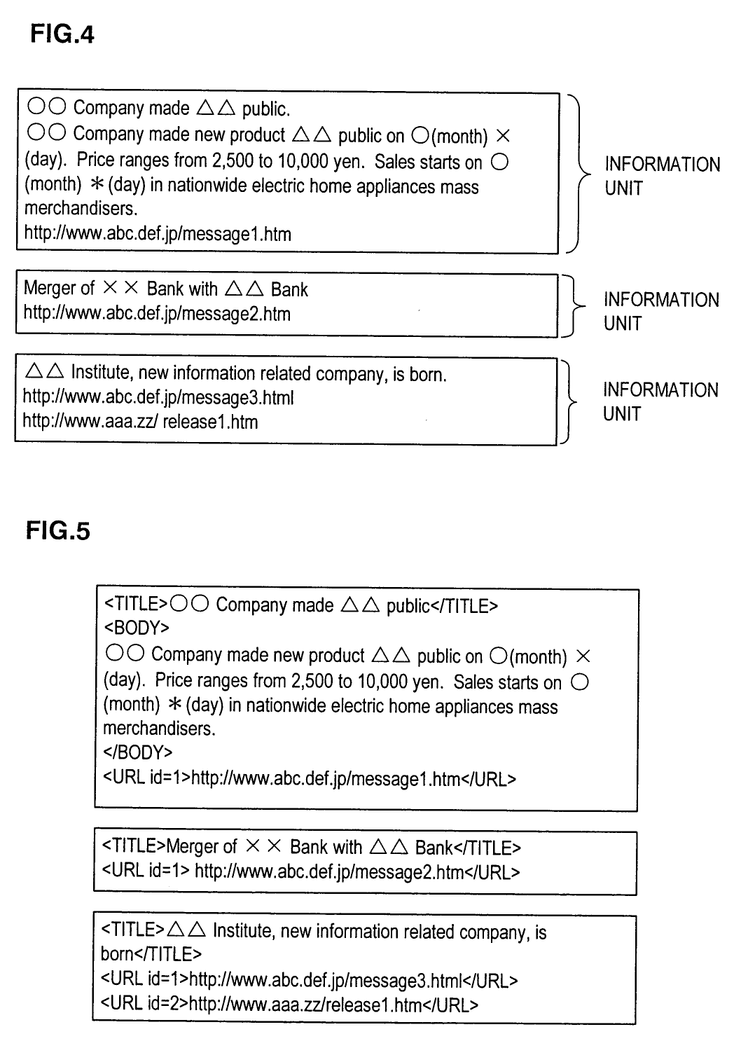

In an information unit extraction processing of a step S201, the information analysis section 101 divides information included in the input e-mail document according to related documents. If the e-mail document is one shown in, for example, FIG. 3, the e-mail document is divided into information units shown in FIG. 4. In this case, to divide the information, parts put between special symbols, blank lines or the like are set as respective information units based on the continuation of the special symbols referred to as separators, the blank lines or the like. Alternatively, based on paragraphs, title symbols or the like, a part until the next paragraph or next title symbols appears may be set as one information unit.

If an URL which indicates the location of detailed information on information is described in each divided information unit, the information unit is extracted.

In this embodiment, an extracted result is expressed in the form of the result marked with tags. For example, for the information units shown in FIG. 4, they are extracted and expressed as shown in FIG. 5. The first line of each information unit is recognized as, for example, a title. In addition, if a plurality of URL's are present in one information unit, the URL's are extracted similarly. In that case, however, an attribute “id” is allocated to each tag and numbered in order of output so as to discriminate the expressions of respective URL's. To discover the URL(s), an ordinary method such as a method by searching a character string starting at http:// may be utilized. The method of expressing URL's after extraction is not limited to the above method as long as a plurality of URL's can be certainly identified.

Processings in steps S202 to S207 are executed for each of the extracted information units.

In a data acquisition processing (an information acquisition processing) of the step S202, the external data acquisition section 102 acquires data from the information source or the like indicated by the URL acquired in the step S201 based on the URL. This data acquisition processing (information acquisition processing) is normally to access a server indicated by the URL through the network and to acquire a corresponding HTML document.

In a determination processing of the step S203, it is determined whether the data indicated by the URL acquired in the data acquisition processing of the step S202 conforms to the content of the information unit which includes the URL. The determination is conducted by, for example, extracting keywords respectively from the acquired data and the content of the information unit, and calculating the conformity of the mutual keywords, and comparing the conformity with a threshold. If it is determined that the data conforms to the content of the information unit, the processing goes to the step S205. If it is determined that they do not conform, the processing goes to the step S204.

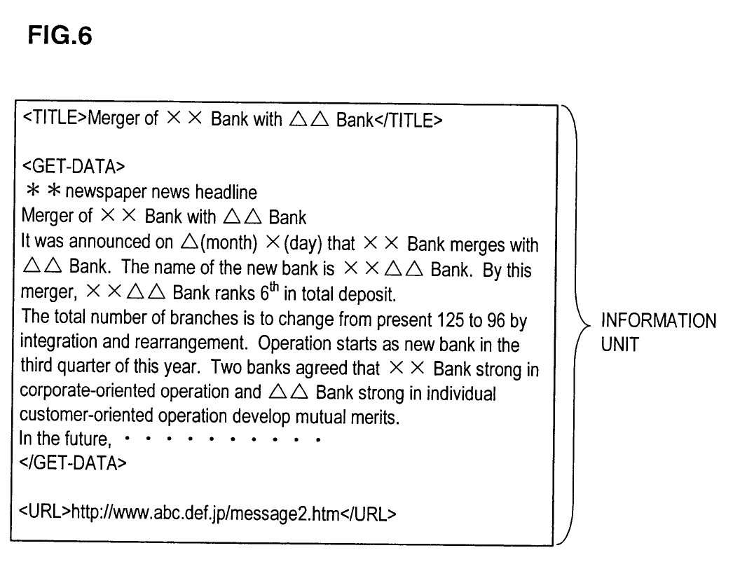

FIG. 6 shows a manner in which acquired data is added to the second information unit of FIG. 5, i.e., the acquired data is expressed by a tag <GET-DATA> added thereto.

In this case, the acquired data is a document, normally referred to as “an HTML document” including control characters. Due to this, the determination processing may be performed after performing a preprocessing for removing control characters other than a hyperlink from the acquired data.

Further, the description contents of the acquired data can be classified by layout or the like. Due to this, after performing a preprocessing for extracting the important part of the acquired data in advance, a determination processing may be performed for the extracted important part.

In a URL change processing of the step S204 to be executed if it is determined that the data indicated by the URL acquired in the data acquisition processing of the step S202 does not conform to the content of the information unit which includes the URL, all the hyperlinks included in the data acquired in advance are extracted, an URL list of the first hierarchy is generated and temporarily stored, and then the data acquisition processing of the step S202 and the determination processing of the step S203 are repeated for the respective URL's. If it is determined that all the data indicated by the URL's acquired in the data acquisition processing of the step S202 do not conform to the contents of the information unit which include the URL's in the URL list of the first hierarchy, hyperlinks are extracted again from the data which can be acquired from the temporarily stored URL list of the first hierarchy, a URL list of the second hierarchy is generated and temporarily stored, and then the data acquisition processing of the step S202 and the determination processing of the step S203 are repeated for the respective URL's.

If the URL included in the information unit is, for example, that of the top page of a company, then all the hyperlinks included in the top page are fetched, the page moves to respective linked Web pages, and it is determined whether or not the respective Web pages relate to the information unit. If it is determined that Web pages related to the URL's of the first hierarchy are not related to the information unit, all the hyperlinks included in the respective Web pages are fetched to search for Web pages related to the information unit.

In this case, the depth of hierarchies at which searches are stopped may be set to a fixed depth or may be arbitrarily set by the user. In any case, it is required that repetition frequency can be limited.

If a plurality of URL's are described in the extracted information unit, data is acquired for a certain URL. If the acquired data is determined not to be related to the information unit, data acquisition and determination are conducted for the next URL repeatedly until the data conforming to the content of the information document is discovered. However, if it is determined that the acquired data for all the URL's do not conform to the content of the information unit, the first hierarchy link processing stated above is performed for a certain URL. Even if there is no acquired data conforming to the content of the information document, the above first hierarchy link processing is performed for the remaining URL's. This processing is repeated (while the depth of hierarchies is restricted) until the acquired data that conforms to the content of the information unit is discovered. Differently from this, data may be acquired for respective URL's and the data having the highest conformity may be selected.

If the information unit extracted in the step S201 does not include any URL, the processings in the steps S202 to S207 for the information unit may be omitted. In addition, it may be regarded that the typical URL of a company which provides the e-mail document (e.g., a mail magazine), the URL of a newspaper company or the like is included in the information unit (the URL may be fixedly set by the system or arbitrarily set by the user) and then the processing may be performed. In this case, the depth of search hierarchies may be equal to that if the information unit includes the URL or may be larger than that.

If the data related to the content of the information unit is acquired, the processing goes to the step S205. If the data related to the content of the information unit is not acquired, the processing may go to a processing for the next information unit or go to the step S205 in which only the processing related to the information unit may be performed (a processing for the acquired data is not executed).

The keyword extraction processing of the step S205 is one of the processings performed by the information addition section 103. In the keyword extraction processing, character strings dealt with as keywords are extracted from the content included in each information unit and the acquired data, respectively. In the determination processing of the step S203, if keywords are extracted, they may be utilized in the step S205. The keyword extraction method is not limited to a specific one but a known method may be used. However, the keywords included in the information unit and those included in the acquired data are managed while being discriminated from one another so as to enable selecting a search target in searching the information unit.

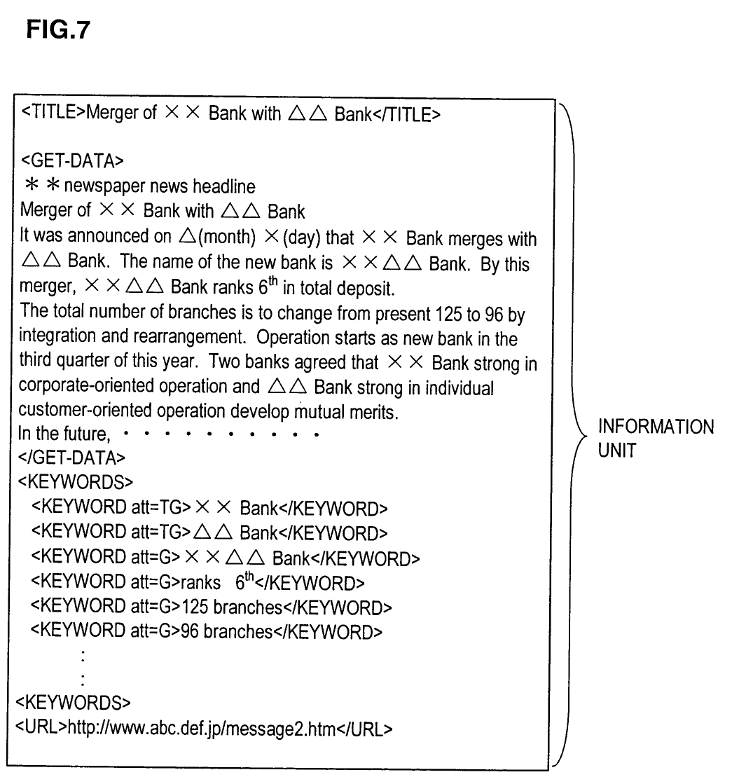

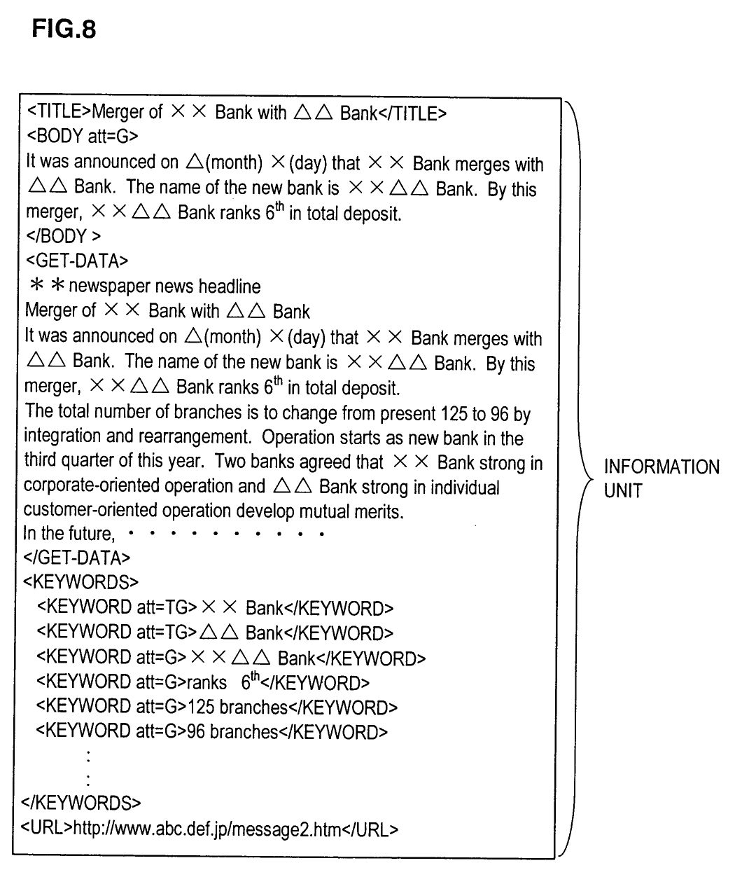

As shown in FIG. 7, for example, the keywords extracted from the information unit and those extracted from the acquired data are allocated tags expressing that they are keywords and also allocated tags attributes of the keywords expressing where the respective keywords are extracted, and the keywords are expressed in the information unit. If a keyword is included in, for example, the information unit, the keyword is allocated an attribute T (title part) or D (summary part). If a keyword is included in the acquired data, the keyword is allocated an attribute G. If a keyword is included in a plurality of parts, the keyword is allocated symbols indicating the parts.

An important part extraction processing of the step S206 is one of the processings performed by the information addition section 103. In the important part extraction processing, only the important part is extracted in the acquired data. As the important part extraction method, an existing method may be utilized similarly to the keyword extraction method. The important part means herein a part similar to the content of the information unit or corresponding to the detail of the content of the information unit in the acquired data. If the number of characters extracted as the important part is not restricted, all the acquired data may be dealt with as the important part. In this concrete example, however, the number of characters is limited to a specific number and the important part is extracted from the acquired data so as to fall within the limited number.

As shown in FIG. 8, for example, the important part is extracted from the acquired data expressed while being put between tags <GET-DATA> and </GET-DATA> and the extracted important part is expressed in the information unit while being put between tags <BODY> and </BODY>. At this moment, the important part is allocated an attribute “G” as information indicating that the important part is gotten from the acquired data. If the important part (or summary) is originally included in the information unit, the important part is allocated an attribute “O”.

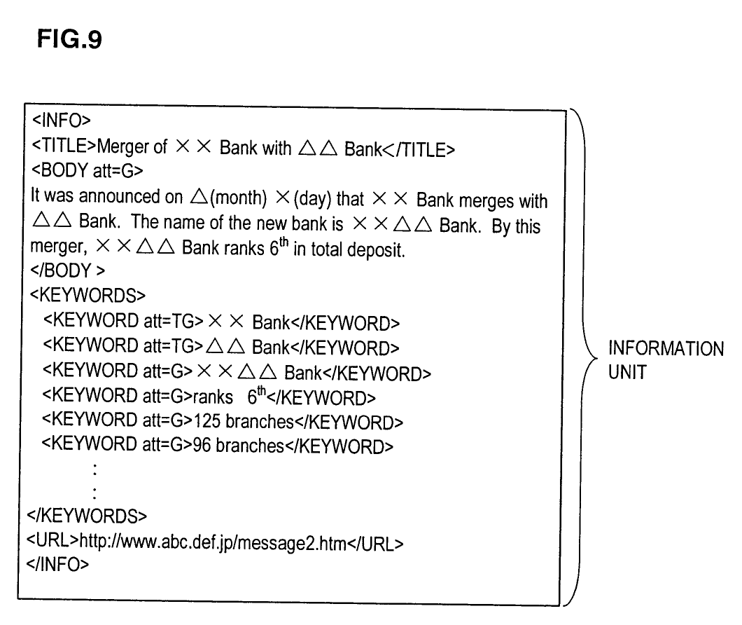

A structured data generation processing of the step S207 is performed by the structured data generation section 104. In this processing, the content of the information unit, the result of the keyword extraction processing (S204) and the result of the important part extraction processing (S205) are combined to generate structured data. As shown in FIG. 9, for example, the structured data is generated while tags are allocated thereto. At this moment, since unnecessary data is included in the acquired data, the unnecessary data is deleted after extracting the important part, thereby improving storage efficiency. Needless to say, the acquired data may be left undeleted.

In a determination processing of the step S208, if a plurality of information units are extracted in the information unit extraction processing (S201), it is determined whether there is an unprocessed information unit. If there is an unprocessed information unit, the processing goes to the step S202.

If all the information units are processed, all pieces of the generated structured data are output. As an output method, display output, printout or transmission output suffices or a storage processing for later display output or printout suffices. Alternatively, not all the generated structured data but the structured data including a keyword designated by the user in advance may be output.

### Advantage of Embodiment

According to this embodiment, the electronic document information addition apparatus is operated as one of the functions of the mail server or mail client. By doing so, if a part indicated by a URL is included in the e-mail document, the e-mail document can be output in a state in which data corresponding to the content of the e-mail document is read from the location indicated by the URL. Therefore, the user can acquire sufficient information without need to designate an URL or acquire information on the URL. If the mail server is particularly provided with an expansion function, the user can acquire sufficient information without need to perform any operations at the time of receiving an e-mail.

Moreover, since not all the acquired data is accumulated but only the important part is extracted from the data corresponding to the content of the e-mail document and accumulated, good storage efficiency is ensured.

Further, the URL information can be acquired simultaneously with the reception of the e-mail, it is possible to view the necessary URL information only by the e-mail viewing software.

Additionally, keywords are extracted from the data acquired from the server indicated by a URL for the information which consists only of a title and the URL and then structured data is generated. Therefore, in accumulating the structured data in a database or the like and then searching the keywords, search efficiency is considerably improved as compared with a case of searching only the title.

### Another Embodiment

The form of the final output of the data from the electronic document information expansion apparatus in the above embodiment may be transformed into the form of an e-mail document or the form in which the data can be viewed by a Web browser at need. In addition, the data may be transmitted to the user as an e-mail. Namely, information units after expansion are not necessarily in the form of structured data.

Furthermore, in determining the similarity (conformity) between the content of the information unit and the data acquired from the server indicated by the URL, data of all the links up to the depth of hierarchies designated in advance may be acquired, respective similarities may be calculated and then the data having the highest similarity may be adopted.

The keyword extraction processing of the step S205 may be executed after the important part extraction processing of the step S206. In that case, the keyword extraction processing is performed for the result of the important part extraction processing.

Moreover, the input e-mail document may not include a plurality of pieces of information. A dedicated apparatus to such e-mail documents does not need to include the division processing means. The electronic document according to the present invention is not limited to the e-mail document but an input document itself may be a Web page or the like. In that case, tags are removed from the Web page and the above-stated series of processings may be conducted or the tags used therefor may be left as they are without removing them. The electronic document may be one provided as a content. Further, data which is already divided into information units may be input and information expansion may be conducted for the respective information units.

In the above-stated embodiment, the URL represents the location of information. The URL may be replaced by a URI, an FTP, a file name or the like.

In the embodiment, the detail of the acquired data is finally removed. Alternatively, the user may be allowed to set whether to remove the detail of the acquired data in advance. That is, the expanded information is not limited to the important part or keywords but may include detailed information on the acquired data, may be intended to expand only the keywords or may be arbitrarily set by the user.

Furthermore, in the embodiment, the case of expanding information has been described. Alternatively, information may be replaced by different information. For example, if a summary is included in information units and a summary in the acquired data is described in more detail (according to, for example, the number of characters or the number of sentences), then the summary included in the information units may be replaced by that included in the acquired data.

In the embodiment, the case of expanding information has been described. In expansion, expanded information or initial information may be translated. For example, if the acquired data fetched is written in a foreign language (a foreign language relative to the initial information or different from a user designated language), the data may be translated into the language that the user can understand or the like and then expanded. Alternatively, information written in both languages may be described in parallel.

It is assumed that a term “expansion” used in claims involves the expansion of information quantity resulting from such replacement and translation.

In addition, if the input electronic document does not include a plurality of pieces of information, the information analysis section 101 does not need to analyze the input electronic document and divide the document into information units.

As described so far, the present invention can provide the electronic document information expansion apparatus, the electronic document information expansion method, the electronic document information expansion program and the recording medium which records the electronic document information expansion program capable of expanding information on an electronic document including the locations of related information.

What is claimed is:

1. An electronic document information expansion apparatus for expanding information on an electronic document comprising:
an input section inputting the electronic document;
an information analysis section extracting location information on data included in an input electronic document from the electronic document;
an external data acquisition section acquiring external data that can be added to the electronic document based on the extracted location information;
an information addition section generating addition data to be added to said electronic document using the acquired external data; and
a structured data generation section combining the addition data generated by said information addition section with said electronic document, and generating structured data with the information on the electronic document expanded.

2. The electronic document information expansion apparatus according to claim 1, wherein said information analysis section analyzes and divides said input electronic document into information units, and extracts the location information on the data included in each of the information units.

3. The electronic document information expansion apparatus according to claim 2, wherein said external data acquisition section acquires the external data that can be reached by tracking the location information up to preset hierarchies from a location indicated by the location information on the data included in each of the information units.

4. The electronic document information expansion apparatus according to claim 2, wherein said external data acquisition section acquires the external data after determining whether the external data is similar to one of the electronic document as an information expansion target and a content of each of the information units.

5. The electronic document information expansion apparatus according to claim 4, wherein said external data acquisition section acquires the external data only when a similarity exceeds a certain threshold in determining whether the external data is similar to one of the electronic document as the information expansion target and the content of each of the information units.

6. The electronic document information expansion apparatus according to claim 4, wherein said external data acquisition section acquires the external data having a highest similarity to one of the electronic document as the information expansion target and the content of each of the information unit in determining whether the external data is similar to one of the electronic document as the information expansion target and the content of each of the information units.

7. The electronic document information expansion apparatus according to claim 4, wherein said external data acquisition section conducts a preprocessing for removing control characters other than a hyperlink, to the external data, in determining whether the external data is similar to one of the electronic document as the information expansion target and the content of each of the information units.

8. The electronic document information expansion apparatus according to claim 4, wherein said external data acquisition section conducts a preprocessing for extracting a keyword, to the external data, in determining whether the external data is similar to one of the electronic document as the information expansion target and the content of each of the information units.

9. The electronic document information expansion apparatus according to claim 2, wherein said information addition section extracts a keyword from the external data acquired by said external data acquisition section.

10. The electronic document information expansion apparatus according to claim 9, wherein said structured data generation section combines a keyword extracted from a content of each of the information units with the keyword extracted from said external data, and generates structured data.

11. The electronic document information expansion apparatus according to claim 9, wherein said structured data generation section generates structured data while discriminating a keyword extracted from a content of each of the information units from the keyword extracted from said external data.

12. The electronic document information expansion apparatus according to claim 1, wherein said electronic document is an e-mail document.

13. An electronic document information expansion method for expanding information on an electronic document, the method comprising:
an information analysis step of extracting location information on data included in an input electronic document from the electronic document;
an external data acquisition step of acquiring external data that can be added to the electronic document based on the extracted location information;
an information addition step of generating addition data to be added to said electronic document using the acquired external data; and
a structured data generation step of combining the addition data generated in said information addition step with said electronic document, and generating structured data with the information on the electronic document expanded.

14. The electronic document information expansion method according to claim 13, wherein in the information analysis step, said input electronic document is analyzed and divided into information units, and wherein
in said information analysis step, said external data acquisitions step, said information addition step, and said structured data generation step, a predetermined processing is conducted to each of said divided information units.

15. The electronic document information expansion method according to claim 14, wherein in said external data acquisition step, the external data that can be reached by tracking the location information up to preset hierarchies is acquired from a location indicated by the location information on the data included in each of the information units.

16. The electronic document information expansion method according to claim 14, wherein in said external data acquisition step, the external data is acquired after determining whether the external data is similar to one of the electronic document as an information expansion target and a content of each of the information units.

17. The electronic document information expansion method according to claim 13, wherein said electronic document is an e-mail document.

18. An electronic document information expansion program in which the steps of the electronic document information expansion method according to claim 13 are described in codes that can be processed by a computer.

19. A recording medium recording the electronic document information expansion program according to claim 18.
